(19) United States
(12) Patent Application Publication
(10) Pub. No.: US 2024/0186864 A1
(43) Pub. Date: Jun. 6, 2024

(54) SYSTEM AND METHOD FOR HARNESSING GRAVITY TO GENERATE, LEVERAGE, AND STORE ELECTRICAL ENERGY

(71) Applicant: Thomas Withers, Royal Oaks, MI (US)

(72) Inventor: Thomas Withers, Royal Oaks, MI (US)

(21) Appl. No.: 18/522,434

(22) Filed: Nov. 29, 2023

Related U.S. Application Data
(60) Provisional application No. 63/429,744, filed on Dec. 2, 2022.
(60) Provisional application No. 63/471,790, filed on Jun. 8, 2023.
(60) Provisional application No. 63/429,765, filed on Dec. 2, 2022.
(60) Provisional application No. 63/471,795, filed on Jun. 8, 2023.

(51) Int. Cl. H02K 7/18; F03G 3/08; F03G 7/08; H02K 7/02; H02S 10/10; H02S 10/20

(52) U.S. Cl. CPC H02K 7/1853; F03G 3/08; F03G 7/081; H02K 7/025; H02S 10/10; H02S 10/20

(57) ABSTRACT

A system and method for generating, leveraging, and storing electrical energy are disclosed. The system comprises one or more walking beams having a track and at least two protective end stops located on opposite ends of the track. A plurality of counterweights is attached to the walking beams, adjacent the axle, via one or more connecting rods. An electric vehicle (EV) chassis is positioned on top of the track and allows back-and-forth movement. The back-and-forth movement makes the walking beam move up and down, which then converts into rotational movement of a flywheel via a rack and pinion arrangement, capturing an alternately falling force of counterweights, thereby rotating the flywheel for generating constant electrical output. Further, an apparatus is adapted for generating artificial fluid lift by utilizing back and-forth movement of the EV chassis.

### BACKGROUND OF THE INVENTION

In the 20^{th}-century grid, electrical power was largely generated by burning fossil fuel. Later, the technology used in generating electricity advanced, requiring less power which results in less fuel being burned. Concerns with air pollution, energy imports, and global warming highlight the detriments of burning fossil fuel on both human's health and the health of the planet where humans live. These concerns ignited significant and steady growth in harnessing renewable energy, such as solar, water and wind power, and conventional oil to generate electricity, given they are sources that do not run out and are of unlimited supply.

The renewable energy industry generates a larger fraction of the overall energy consumption. Hence, various solutions have been developed to store the power from these intermittent sources. However, there are issues with the current state of natural element energy sourcing. Wind power is uncontrollable, unpredictable, and may be generated when no additional power is needed or an insufficient amount of energy may be generated depending upon the state of wind flow. Solar power varies with cloud cover and, at best, is only available during daylight hours, while demand often peaks after sunset. Solar power also varies in availability throughout the year as the amount of sunlight changes over the course of a year and varies based on latitude. Solar power also requires an expansive area, and the amount of energy generated from solar energy is dependent upon the surface area of the solar panels, which means, to generate a significant amount of energy, there must be a significant area of panels.

The conventional oil is extracted from underground reservoirs using traditional drilling and pumping methods. Oil accounts for approximately 3% of the Global Domestic Product and is one of the most important commodities in the world. Petroleum products, which are made out of oils, can be found in everything from personal protective equipment, plastics, chemicals, and fertilizers to aspirin, clothing, fuel for transportation, and even solar panels. Due to global warming, it is important and responsible to extract this oil in the most energy-efficient manner possible. Current artificially lifting fluid systems use almost as much energy as will be produced from the extracted fluids themselves.

All current gravity energy system designs use large electric motors to lift heavy weights to be dropped. For example, the current systems operate by lifting 100,000 pounds to create 100,000 pounds of potential energy. Traditionally, sucker rod strings have been utilized by a pump jack, which operates through the rotation of a crank driven by a prime mover. These mechanisms have been utilized in the oil production industry for decades and continue to be a primary method for extracting oil from a well.

For 150 years, pump jacks or beam pumping units have been used by the petroleum industry to extract crude oil from wells. Pump jacks encompass approximately 71% of the artificial lift machinery in the oil production field. The vast majority use electricity as their prime mover, which is a device that provides power to operate the pump jack.

FIG. 1 exhibits the traditional components of pump jack 100, which are limited by their geometry. This is due to the rotational velocity of a prime mover 107 arrangement converting to linear velocity of a sucker rod string 117. This conversion is made via mechanical connections of a crank 105, pitman arm 103, walking beam 102, and sucker rods 111. The crank 105 is a rotating shaft that is connected to the pitman arm 103 and converts the rotary motion of the prime mover 107 into the reciprocating motion of the walking beam 102. A pitman arm 103 is a lever arm that connects the walking beam 102 to the crankshaft of the prime mover 107 and converts the rotary motion of the crankshaft into the reciprocating motion of the walking beam 102. A walking beam 102 is connected to the horsehead 101 of the pump jack and reciprocates up and down to operate the pump. Sucker rods are jointed rods that connect to a pump plunger in a subterranean well with a walking beam at the surface. These rods 111 move up and down to artificially increase pressure within a well to pull the oil to the Earth's surface.

The prime mover runs a set of pulleys to the transmission, often a double-reduction gearbox 108, which drives a pair of cranks with counterweights 104 installed on them to offset the weight of the heavy rod assembly. A horsehead 101 is a large, U-shaped structure that sits on top of the walking beam 102 and supports the sucker rod string 110, which connects the pumping unit to the polished rod 111. The counterweight 104 is a weight that is attached to the opposite end of the walking beam 102 from the horsehead 101 and helps to balance the weight of the pumping unit and the pump jack.

V-belts 106 are flexible belts with a V-shaped cross-section that transmit power from the prime mover 107 to the gear reducer 108 or other equipment. Prime movers 107 are motors that provide power to operate the pumping unit. Gear reducers 108 are devices that reduce the speed and increase the torque of the power transmitted from the prime mover 107 to the walking beam 102. Samson posts 109 are two vertical posts that are attached to the foundation and provide support for the walking beam 102. Sucker rod strings 110 support the weight of the pump jack and connect it to the walking beam 102. A polished rod 111 is attached to the top of the sucker rod string 110 and extends upward from the pump jack. The stuffing box 112 is a device that seals the space between the polished rod 111 and the pump jack and prevents leakage of fluid from the well.

The tee 114 is a fitting in a pipeline that has three openings and is used to divert or combine the flow of fluids. The tubing 116 is installed in the wellbore and is used to convey fluids from the pump jack to the surface. Cement 118 is pumped into the wellbore and used to seal the annulus 120 between the casing 119 and the formation. The casing 119 is a large-diameter steel pipe installed in the wellbore and used to support the well's walls and prevent collapse. The annulus 120 is the space between the casing and the formation, which is filled with cement 118 to provide a seal and prevent the migration of fluids between different zones.

The oil-bearing zone 121 is a geological formation that contains oil and can be produced using a pumping unit and downhole pump. The perforations 122 are holes that are made in the casing 119 and cement 118 to allow fluids to flow from the formation into the wellbore. The traveling valve 123 opens and closes to allow fluid to flow into and out of the pump barrel. Pump barrels 124 are cylinders that are attached to the bottom of the sucker rod string 110 and contain the traveling valve 123 and standing valve 125. A standing valve 125 is installed in the bottom of the pump barrel 124 and opens and closes to allow fluid to flow into and out of the pump barrel.

Large electric motors traditionally power pump jacks, while V-belts 106 provide traction, speed, and load capabilities. When torque is applied by a motor to the power shaft, the counterweights lift to the walking beam, therefore submerging the sucker rod. Gear reduction equipment 108 converts energy into a high-torque output for the pump jack. This allows the torque and speed between a motor and a load to be modified as needed.

Any change to rod string 110 velocity requires a change in prime mover 107 rotational velocity and a mechanical change of the pump and jack components. A variable frequency drive on an AC driven pump jack can provide some variation in prime mover RPM, but the variability is still limited. This solution has two other problems. First, variable frequency motors and variable frequency control cabinets are expensive. These devices operate as control centers for the components used to save energy. The second issue is it increases electricity and maintenance costs.

Though pump jacks have been used by the petroleum industry to extract crude oil from wells, the energy efficiency of these artificial lift machines with their large motors, gearing, and counterweights ranges from only 12% to 23%. Another disadvantage of this technique is the inevitable need to use electrical lines in remote locations. This is often a costly undertaking that relies on grid power with frequently occurring power outages that create expensive downtime. This, in turn, results in lost oil production. Additionally, pump jacks have many awkwardly moving parts and require expensive maintenance, especially with the added strain on equipment from deeper and horizontally drilled wells. Furthermore, the current system of extracting oil will eventually no longer be a viable solution. There are currently no clean-tech artificial lifting systems available that use significantly less energy than is produced.

Accordingly, long-duration energy storage is required to transition the world completely, and gravity energy storage systems are a possible solution. Gravity energy storage systems operate on the principle of converting kinetic energy to potential energy by lifting a weight and dropping that weight which will then rotate a generator with an expected round-trip-efficiency of about 85%. Currently, known methods of large-scale gravity storage include running loaded rail cars attached to electrical generators up inclines and releasing them downhill when electricity is needed; dropping weights attached to electrical generators down abandoned mine shafts when electricity is needed; dropping weights attached to electrical generators when electricity is needed; and dropping weights off self-reloading high towers when electricity is needed.

These known methods are fraught with functional obstacles, such as adverse site locations. The known methods require a lack of proximity to population centers in order to be constructed, due to the large size required of the devices. The current methods also pose environmental disadvantages, including the degradation of land and/or ocean resources. Additionally, current methods are disadvantaged by technically challenging and/or expensive system configurations.

There is a need for applying a simple and inexpensive means of harnessing gravity to generate and store electrical energy. Potential energy gets converted to kinetic energy and then back again. Potential energy is the type that generates from natural resources, such as sunlight. This type of energy is a green energy which has significant environmental advantages.

Therefore, there is a need for a system and method for harnessing gravity to generate, leverage, and store electrical energy. Also, there is a need for an apparatus adapted for generating artificial lift by utilizing solar-powered EVs and leverage.

### SUMMARY OF THE INVENTION

The present invention relates to a system for generating, leveraging, and storing electrical energy. The system provides a simple and inexpensive solution for harnessing gravity to generate and store electrical energy. In one embodiment, the system acts as an energy generating device, an energy leveraging device, and/or an energy storage device.

One aspect of the present disclosure is directed to a system for harnessing gravity to generate, leverage, and store electrical energy, comprising: (a) one or more walking beams, wherein each walking beam comprises a track having at least two protective end stops located on opposite ends of the track, wherein each walking beam is affixed to one end of an upright support stanchion post via an axle; (b) a plurality of counterweights attached to the walking beam adjacent to the axle via one or more connecting rods; (c) an electric vehicle (EV) chassis positioned on top of the track and allowed to move back and forth on the track, wherein the back-and forth movement of the EV chassis is limited by the protective end stops; and (d) a flywheel attached to the walking beams via a rack and pinion arrangement, wherein the back and forth movement of the EV chassis along the track causes the walking beam to move up and down, wherein the up and down movement of the walking beam is converted into a rotational movement via the rack and pinion arrangement to capture an alternately falling force of the counterweights, thereby rotating the flywheel for generating constant and uniform electrical output. In one embodiment, the system generates clean electricity, for the production of green hydrogen and grid stabilization (H2—Peaker's) with zero GHG-emissions, Archimedes Gravity Energy System (AGES).

In one embodiment, the walking beams are connected and supported by a reinforced concrete support structure. In another embodiment, the protective end stops are in the form of springs. In another embodiment, the protective end stops at the ends of the tracks are connected to another end of the upright support stanchion posts via a support cabling. In one embodiment, the upright support stanchion post is perpendicular to the respective walking beam. In another embodiment, the connecting rod moves vertically configured to allow the corresponding walking beam to move up and down within a desired range. In one embodiment, the EV chassis is positioned on top and connected to the track configured to move along the length of the track.

In one embodiment, the back-and-forth movement of the EV chassis on the track at a desired speed generates electrical energy. In one embodiment, the EV chassis moves continuously on the track using a connection between the upright support sanction posts and the track at an axis. In one embodiment, the EV chassis moves along the track through gravitational effect of the counterweights against the weight of the EV chassis. In one embodiment, the falling force of the counterweights utilizes gravitational energy that enables the EV chassis to travel back and forth on the track to efficiently control the weight of the EV chassis for generating electricity and long-term energy storage. In one embodiment, the counterweights leverage the weight of the EV chassis and its movement along the length of the track to generate more potential energy.

In another embodiment, the walking beams are inclined to the upright support stanchion posts and leveraged to use a small amount of energy to lift a small weight to create more potential energy. In one embodiment, the back-and-forth movement of the EV chassis causes the walking beam to move up and down configured to convert the potential energy of the walking beam into kinetic energy. In another embodiment, the potential energy is converted into kinetic energy through a clockwise movement of the flywheel. In one embodiment, the kinetic energy is converted into a rotational movement of the flywheel configured to generate constant and uniform electrical energy. In one embodiment, the flywheel comprises an electrical generator configured to store the generated electrical energy. In another embodiment, the flywheel is connected to the electrical generator via the rack and pinion arrangement. In another embodiment, they system further comprises one or more solar PV panels attached to the top of the EV chassis configured to charge a battery unit coupled to the EV chassis. In one embodiment, the system is adapted for generating artificial fluid lift by utilizing back and forth movement of the EV chassis.

Another aspect of the present disclosure is directed to an apparatus for generating artificial fluid lift, comprising: (a) at least one walking beam having a distal end and a proximal end, wherein the walking beam comprises a track attached to the distal end, wherein the track includes at least two protective end stops located on opposite ends of the track, wherein the walking beam is affixed to one end of one or more upright support stanchion posts via an axle; (b) a curved metal head attached to the proximal end of the walking beam via connecting member; (c) an electric vehicle (EV) chassis positioned on top of the track and allowed to move back and forth on the track, wherein the back and forth movement of the EV chassis is limited by the protective end stops; and (d) a sucker rod string having an upper end attached to the curved metal head and a lower end attached to a subterranean wellhead, wherein the back and forth movement of the EV chassis along the track enables the walking beam to tilt on the axle of the upright support stanchion posts to a maximum decline angle, wherein the tilting of the walking beam causes the curved metal head to move up and down, thereby allowing the sucker rod string to move up and down through the wellhead and descend into the wellbore to artificially increase pressure and extract the fluid.

In one embodiment, the walking beam is perpendicularly affixed to one end of the upright support stanchion posts with cabling via the axle. In another embodiment, the axle is placed in the middle of the walking beam configured to allow for a greater stroke range. In another embodiment, the back-and-forth movement of the EV chassis raises and lowers the walking beam. In one embodiment, the sucker rod string moves up and down based on the speed of the movement of the EV chassis across the track. In a related embodiment, the back-and-forth movement of the EV chassis enables the up and down movement of the walking beam and sucker rod string to a maximum angle at a maximum stroke range. In another embodiment, the maximum decline angle of the walking beam is determined by one or more walking beam stops located on the upright support stanchion posts. In one embodiment, the walking beam comprises a plurality of lattice bars interconnected in an articulated manner configured to form a walking beam lattice support structure. In a related embodiment, the walking beam lattice support structure serves as a support structure for the the curved metal head, protective end stops, upright support stanchion posts, and cablings.

In one embodiment, the curved metal head has an elliptical shape configured to maintain a perpendicular alignment of the sucker rod string while moving up and down to extract oil. In one embodiment, the EV chassis is powered by one or more EV batteries. In a related embodiment, the battery packs are recharged using one or more solar PV panels coupled to the top of the EV chassis. In one embodiment, the back and forth movement of the EV chassis between the protective end stops on the track allows the EV batteries to remain charged.

Another aspect of the present disclosure is directed to a method of artificially lifting fluids from borewell using an apparatus comprising a walking beam having a track attached to a distal end and a curved metal head attached to a proximal end, an electric vehicle (EV) chassis positioned on top of the track configured to move back and forth along the track, and a sucker rod string having an upper end attached to the curved metal head and a lower end attached to a subterranean wellhead, wherein the method comprises the steps of: (a) mounting the walking beam on top of one or more upright support stanchion posts with cablings via an axle, wherein the axle is placed in the middle of the walking beam; (b) allowing the EV chassis to move back and forth on the track of the walking beam; (c) enabling the walk beam to tilt on the axle of the upright support stanchion posts to a maximum decline angle: and (d) enabling the curved metal head to move up and down, thereby allowing the sucker rod string to move up and down through the wellhead and descend into the wellbore to artificially increase pressure and extract the fluid.

In one embodiment, the back-and-forth movement of the EV chassis is limited by at least two protective end stops. In another embodiment, the back-and-forth movement of the EV chassis raises and lowers the walking beam. In yet another embodiment, the sucker rod string moves up and down based on the speed of the movement of the EV chassis across the track. In one embodiment, the back-and-forth movement of the EV chassis enables the up and down movement of the walking beam and sucker rod string to a maximum angle at a maximum stroke range. In one embodiment, the maximum decline angle of the walking beam is determined by one or more walking beam stops located on the upright support stanchion posts. In another embodiment, the curved metal head has an elliptical shape configured to maintain a perpendicular alignment of the sucker rod string while moving up and down to extract oil. In one embodiment, the disclosure is directed to an artificial lift system to extract oil, and white hydrogen with zero GHG-emissions, Zero Emissions Artificial Lift (ZEAL).

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

FIG. 1 exemplarily illustrates a perspective view of a traditional pump jack system;

FIG. 2 exemplarily illustrates a perspective view of a system for generating and storing electrical energy, according to an embodiment of the present invention;

FIG. 3 exemplarily illustrates a graph showing the positioning of one or more components of the system, according to one embodiment of the present invention;

FIG. 4A exemplarily illustrates an electric vehicle (EV) chassis resting on a protective end stop and a sucker rod string at the bottom of a downstroke, according to one embodiment of the present invention;

FIG. 4B exemplarily illustrates an electric vehicle (EV) chassis in the center of a track and the sucker rod string in the middle of an upstroke, according to one embodiment of the present invention; and

FIG. 4C exemplarily illustrates an electric vehicle (EV) chassis resting on the protective end stop and the sucker rod string at the top of the upstroke, according to one embodiment of the present invention.

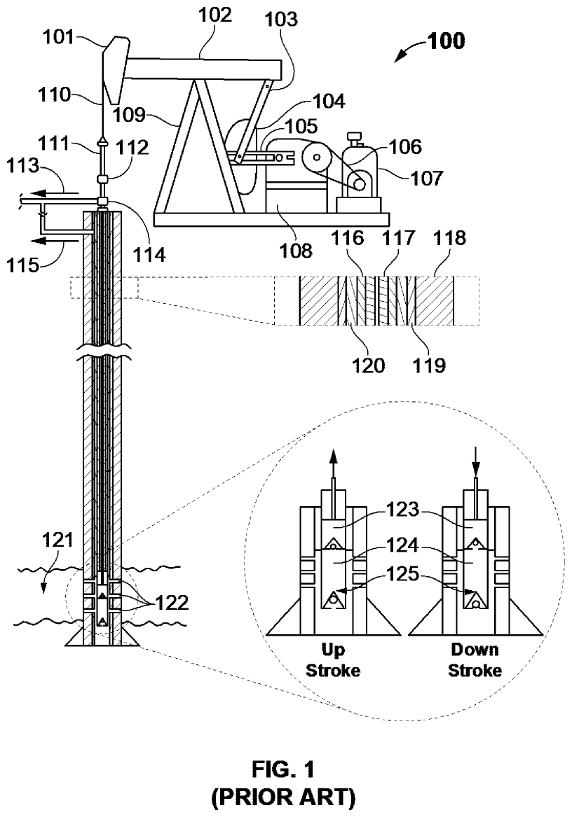

### DETAILED DESCRIPTION

The present disclosure discloses a system for harnessing gravity to generate and store electrical energy. Also, the present disclosure discloses an apparatus and method for generating artificial fluid lift.

A description of embodiments of the present disclosure will now be given with reference to the figures. It is expected that the present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

Before any embodiments of the invention are explained in detail, it is to be understood that the disclosure is not limited in its application to the details of construction nor to the arrangement of components set forth in the following description or illustrated in the drawings. The disclosure is capable of other embodiments and of being practiced or of being carried out in various ways.

The present invention relates to a system for generating, leveraging, and storing electrical energy. The system provides a simple and inexpensive solution for harnessing gravity to generate and store electrical energy. In one embodiment, the system acts as an energy generating device. In one embodiment, the system acts as an energy leveraging device. In one embodiment, the system acts as an energy storage device.

The system comprises one or more walking beams. Each walking beam comprises a track. The track has at least two protective end stops located on opposite ends of the track. Each walking beam is affixed to one end of an upright support stanchion post via an axle. The walking beams are connected and supported by a reinforced concrete support structure.

The system further comprises an electric vehicle (EV) chassis or EV skateboard. The EV chassis is advantaged by regenerative braking. The EV chassis is able to move back and forth on the track. The EV chassis is positioned on top and connected to the track to move along the length of the track. The back-and-forth movement of the EV chassis is limited by the two protective end stops. In one embodiment, the protective end stops are in the form of springs.

The system further comprises one or more upright support stanchion posts configured to support the walking beams. Each walking beam is supported by at least one upright support stanchion post. The upright support stanchion post is perpendicular to the respective walking beam. The walking beam is perpendicularly affixed to one end of the upright support stanchion post via an axle or pivot point. Further, the protective end stops at the ends of the tracks are connected to another end of the upright support stanchion posts via one or more support cablings.

The system further comprises a plurality of counterweights. At least one counterweight is attached to one walking beam adjacent to the axle. The counterweights are attached to the walking beam via one or more connecting rods. The connecting rods may vary in length. The connecting rods move vertically to allow the corresponding walking beam to move up and down within a desired range. The counterweights permit a means of using gravitational energy that enables the EV chassis to travel back and forth on the track to efficiently control the counterweights to generate electricity and long-term energy storage.

The system further comprises a flywheel attached to the walking beams via a rack and pinion arrangement. The flywheel comprises an electrical generator. The flywheel is connected to the electrical generator via the rack and pinion arrangement. The system further comprises an additional weight unit. The additional weight unit may be a prefabricated, economical deployment of large-scale solar electric systems. The solar electric system includes one or more solar PV panels. The PV panels are connected to one or more charging equipment or EV batteries that are attached to the EV chassis. The EV panels are configured to charge the EV batteries coupled to the EV chassis. The system offers benefits from leveraging EV batteries for electrical energy generation and long-term energy storage.

In one embodiment, the EV chassis moves back and forth along the track at a desired speed. The back-and-forth movement of the EV chassis at the desired speed generates electrical energy. When the EV chassis reaches the end of the walking beams by travelling back and forth on the track without stopping, the speed and breaking of the EV chassis are program controlled, and they are in a leveraged position and lift the counterweights. The EV chassis moves continuously on the track at an axis using a connection between the upright support sanction posts and the track. In one embodiment, the EV chassis moves along the track through a gravitational effect of the counterweights against the weight of the EV chassis. The counterweights leverage the weight of the EV chassis and its movement along the length of the track to generate more potential energy.

In one embodiment, the back-and-forth movement of the EV chassis causes the walking beam to move up and down configured to convert the potential energy of the walking beam into kinetic energy. In one embodiment, the potential energy is converted into kinetic energy through a clockwise movement of the flywheel. The kinetic energy is converted into a rotational movement of the flywheel. In one embodiment, the up and down movement of the walking beam is converted into the rotational movement of the flywheel via the rack and pinion arrangement to capture the alternately falling force of the counterweights, thereby rotating the flywheel configured to generate constant and uniform electrical output.

The falling force of the counterweights permits the usage of gravitational energy that enables the EV chassis to travel back and forth on the track to efficiently control the weight of the EV chassis for generating electricity and long-term energy storage. In one embodiment, the flywheel comprises an electrical generator configured to store the generated electrical energy. Further, the system benefits from the inclined walking beams and leverage to use a small amount of energy to lift a small weight to create much greater potential energy resulting in a previously unattainable of at least 90% round-trip efficiency and a significantly longer-duration energy storage system.

In one embodiment, an apparatus for harnessing gravity for generating and storing electrical energy is disclosed. The apparatus utilizes the mechanical advantages of leverage and an inclined plane to harness gravity for electricity generation. The apparatus is adapted for generating artificial lift by utilizing solar-powered electric vehicles (EV) and leverage. The apparatus artificially lifts fluids using solar energy as a readily available source of no-cost fuel.

The apparatus comprises at least one walking beam or inclined plane. The walking beam is a lattice framework roadway platform. The walking beam comprises a plurality of lattice bars interconnected in an articulated manner configured to form a walking beam lattice support structure. The walking beam comprises a proximal end and a distal end. The walking beam comprises a track on the distal end. The walking beam further comprises at least two protective end stops and one or more lead weights. The protective end stops are located on opposite ends of the track. The lead weights are 8-pound barbells. The lead weights are attached to the walking beam via two 10-foot U-bolts.

The apparatus further comprises an electric vehicle (EV) chassis. The EV chassis is advantaged by regenerative braking. The EV chassis is positioned on top and connected to the track to move along the length of the track. The back-and-forth movement of the EV chassis is limited by the two protective end stops. In one embodiment, the protective end stops are in the form of springs.

The apparatus further comprises a curved metal head or horsehead. The curved metal head is attached to the proximal end of the walking beam. The curved metal head is attached to the proximal end of the walking beam via a connecting member or hand-built wooden-rack. The apparatus further comprises one or more upright support stanchion posts configured to support the walking beam. The walking beam is supported by at least two upright support stanchion posts. The upright support stanchion posts are stainless steel samson posts. The upright support stanchion post is perpendicular to the walking beam.

The walking beam is perpendicularly affixed to one end of the upright support stanchion posts via an axle or pivot point. The axle is placed in the middle of the walking beam to allow for a greater stroke range. The axle is cradled by at least two walking beam stops. The walking beam serves as a framework for the curved metal head, protective end stops, upright support stanchion posts and cablings. Additionally, the walking beam is held to a maximum angle of about 20-degree declined by 3,000 pound protective end stops located on the upright support stanchion post.

The apparatus further comprises a sucker rod string. The sucker rod string has an upper end and a lower end. The upper end is attached to the curved metal head and the lower end is attached to a subterranean wellhead. In one embodiment, the back-and-forth movement of the EV chassis along the track enables the walking beam to tilt on the axle of the upright support stanchion posts to a maximum decline angle. The tilting of the walking beam enables the curved metal head to move up and down, thereby allowing the sucker rod string to move up and down through the wellhead and descend into the wellbore to artificially increase pressure and extract the fluid.

The apparatus further comprises one or more solar PV panels. The PV panels are attached to the top of the EV chassis using one or more standard solar array mounting brackets. The PV panels are connected to one or more charging equipment or EV batteries that are attached to the EV chassis. The EV panels are configured to charge the EV batteries coupled to the EV chassis.

In one embodiment, the apparatus features the axle in the middle of the 28-foot walking beam to allow for a greater stroke range. The EV chassis moves back and forth along the track of the walking beam. The EV chassis moves back and forth seven feet to create the required motion for oil extraction. The EV chassis moves back and forth in a limited fashion to create the required back and forth motion for oil extraction. This limited movement permits the solarization of the EV chassis for a completely self-contained means of extracting oil with no fuel required or greenhouse gas (GHG) emissions.

The curved metal head attached to the sucker rod string breaks through the wellhead and descend into the earth's wellbore. The sucker rod string rises and lowers based on the speed of the movement of the EV chassis across the walking beam. The back-and-forth movement of the EV chassis causes the walking beam to tilt on the axle of the upright support stanchion posts. The maximum decline angle of the walking beam is determined by the walking beam stops on the upright support stanchion posts. The sucker rod string moves up and down in the subterranean wellbore to artificially increase pressure and extract the fluid.

In one embodiment, the present invention utilizes a method for artificially lifting fluids from a borewell using the apparatus. The method comprises the following step of mounting the walking beam in the middle of an axle. The axle is affixed to one or more upright support stanchion posts. There is the step of allowing the EV chassis to move back and forth between the two protective end stops on the track. In one embodiment, the back-and-forth movement of the EV chassis is limited by the two protective end stops. The back-and-forth movement of the EV chassis raises and lowers the walking beam. There is another step of enabling the walk beam to tilt on the axle of the upright support stanchion posts to a maximum decline angle. In one embodiment, the maximum decline angle of the walking beam is determined by one or more walking beam stops located on the upright support stanchion posts. There is another step of enabling the curved metal head to move up and down, thereby allowing the sucker rod string to move up and down through the wellhead and descend into the wellbore to artificially increase pressure and extract the fluid.

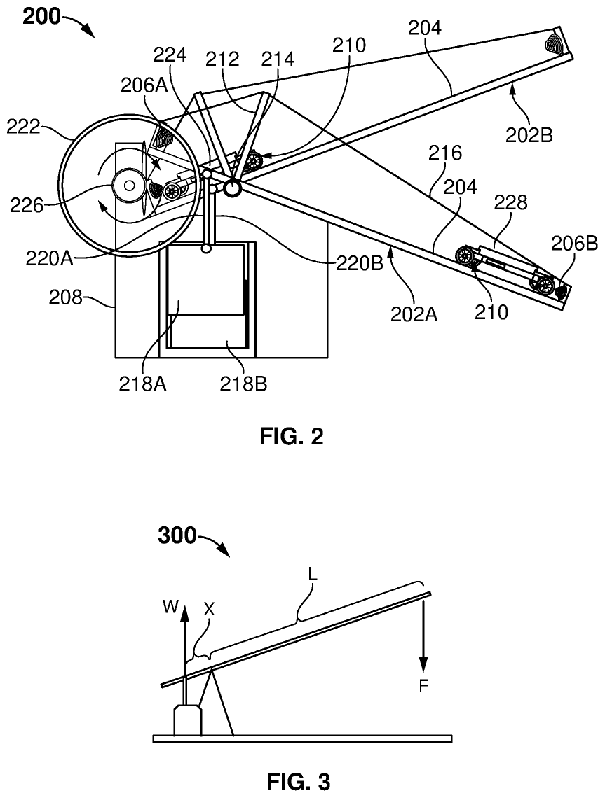

Referring to FIG. 2, a perspective view of a system 200 for energy generation and energy storage according to an embodiment is illustrated. The system 200 provides a simple and inexpensive solution for harnessing gravity to generate and store electrical energy and could be utilized in an environmentally friendly manner in heavily populated areas. The system 200 is intended to be used as back-up energy to help firm up intermittent renewable energy, it also can be utilized as a ‘black start’ for bringing the grid back online in the event of an outage, as well as grid balancing, peak-shaving, and back feeding to generate revenue. In one embodiment, the system 200 acts as an energy generating device. In one embodiment, the system 200 acts as an energy leveraging device. In one embodiment, the system 200 acts as an energy storage device.

The system 200 comprises one or more inclined planes or walking beams (202A, 202B) including a first walking beam 202A and a second walking beam 202B. The two walking beams (202A, 202B) have a length of about 50 feet. In one embodiment, the two walking beams can be configured to be about 30, 60 or 100 feet. In another embodiment, the two waling beams can be configured to be about 130, 160, 190 or 220 feet. The walking beams (202A, 202B) are lattice framework roadway platforms. Each walking beam (202A, 202B) comprises a proximal end and a distal end. The first walking beam 202A comprises a first proximal end and a first distal end, whereas the second walking beam 202B comprises a second proximal end and a second distal end.

Each walking beam (202A, 202B) comprises a track or a roadway platform 204. The track 204 has at least two protective end stops (206A, 206B) located on opposite ends of the track 204. The protective end stops (206A, 206B) are located at the proximal end and the distal end of the walking beams (202A, 202B). Further, the walking beams (202A, 202B) are connected and supported by a reinforced concrete support structure 208. In one embodiment, the first proximal end of the first walking beam 202A and second proximal end of the second walking beam 202B are attached to an upper section of the reinforced concrete support structure 208.

The system 200 further comprises an electric vehicle (EV) chassis or EV skateboard 210. The EV chassis 210 is advantaged by regenerative braking. The EV chassis 210 is a standard flatbed rail cars with steel wheels. The EV chassis 210 uses standard steel rails to economically, and with great efficiency, carry 100,000 pounds of weight. The EV chassis 210 allowed to move back and forth on the track 204 on the track 204. The EV chassis 210 is positioned on top and connected to the track 204 to move along the length of the track 204. The back-and-forth movement of the EV chassis 210 is limited by the two protective end stops (206A, 206B). In one embodiment, the protective end stops (206A, 206B) are in the form of springs.

The system 200 further comprises one or more upright support stanchion posts 212 configured to support the walking beams (202A, 202B). Each walking beam (202A, 202B) is supported by at least one upright support stanchion post 212. The upright support stanchion post 212 is perpendicular to the respective walking beam (202A, 202B). The walking beam (202A, 202B) is perpendicularly affixed to one end of the upright support stanchion post 212 via an axle or pivot point 214. Further, the protective end stops (206A, 206B) at the ends of the tracks 204 are connected to another end of the upright support stanchion posts 212 via one or more support cablings 216.

The system 200 further comprises a plurality of counterweights (218A, 218B). At least one counterweight (218A, 218B) is attached to one walking beam (202A, 202B) adjacent to the axle 214. The counterweights (218A, 218B) weigh about 100,000 pounds. The counterweights (218A, 218B) are attached to the walking beam (202A, 202B) via one or more connecting rods (220A, 220B). The connecting rods (220A, 220B) may vary in length. The connecting rods (220A, 220B) move vertically to allow the corresponding walking beam (202A, 202B) to move up and down within a desired range. The counterweights (218A, 218B) permit a means of using gravitational energy that enables the EV chassis 210 to travel back and forth on the track 204 to efficiently control the weight of 100,000 pounds for the purpose of generating electricity and long-term energy storage.

The system 200 further comprises a flywheel 222 attached to the walking beams (202A, 202B) via a rack and pinion arrangement 224. The flywheel 222 comprises an electrical generator 226. The flywheel 222 is connected to the electrical generator 226 via the rack and pinion arrangement 224.

The system 200 further comprises an additional weight unit. The additional weight unit may be a prefabricated, economical deployment of large-scale solar electric systems. The solar electric system includes one or more solar PV panels 228. The PV panels 228 are attached to the top of the EV chassis 210 using one or more standard solar array mounting brackets. The PV panels 228 are connected to one or more charging equipment or EV batteries that are attached to the EV chassis 210. The PV panels 228 are configured to charge the EV batteries coupled to the EV chassis 210. The system 200 offers benefits from leveraging EV batteries for electrical energy generation and long-term energy storage. Further, the PV panels 228 and EV batteries are used for a second-life battery application.

During working, the system 200 utilizes the EV chassis 210 to move back and forth along the track 204 of the walking beams (202A, 202B). The EV chassis 210 weighing about 8,000 pounds with added weight of about 2,000 pounds, 10,000 pounds in total, travel back and forth on the track 204 at a desired speed. In one embodiment, the EV chassis 210 travels at a speed of about 6.82 MPH on the track 204. The back-and-forth movement of the EV chassis 210 at the desired speed generates electrical energy.

The EV chassis 210 reach the end of the walking beams (202A, 202B) by travelling back and forth on the track 204 without stopping. The speed and breaking of the EV chassis 210 are program controlled, and they are in a leveraged position and lift the counterweights (218A, 218B) of 100,000-pounds in weight. The EV chassis 210 moves continuously on the track 204 at an axis using a connection between the upright support sanction posts 212 and the track 204. In one embodiment, the EV chassis 210 moves along the track 204 through a gravitational effect of the counterweights (218A, 218B) against the weight of the EV chassis 210. The counterweights (218A, 218B) leverage the weight of the EV chassis 210 and its movement along the length of the track 204 to generate more potential energy.

The back-and-forth movement of the EV chassis 210 causes the walking beam (202A, 202B) to move up and down. In one embodiment, the back-and-forth movement of the EV chassis 210 causes the walking beam (202A, 202B) to move up and down configured to convert the potential energy of the walking beam (202A, 202B) into kinetic energy. In one embodiment, the potential energy is converted into kinetic energy through a clockwise movement of the flywheel 222. The kinetic energy is converted into a rotational movement of the flywheel 222. In one embodiment, the up and down movement of the walking beam (202A, 202B) is converted into the rotational movement of the flywheel 222 via the rack and pinion arrangement 224 to capture the alternately falling force of the counterweights (218A, 218B), thereby rotating the flywheel 222 that is configured to generate constant and uniform electrical output.

The falling force of the counterweights (218A, 218B) permits the usage of gravitational energy that enables the EV chassis 210 to travel back and forth on the track 204 to efficiently control the weight of EV chassis 210 for generating electricity and long-term energy storage. In one embodiment, the flywheel 222 comprises an electrical generator 226 configured to store the generated electrical energy.

In one embodiment, the system 200 utilizes the walking beams (202A, 202B) that move through a combination of the 100,000 lbs counterweights (218A, 218B) and the EV chassis 210 with 10,000 lbs weight configured to generate the electrical energy.

In one embodiment, the system 200 utilizes the track 204, EV chassis 210, and the counterweights (218A, 218B) that leverages the weight of the EV chassis 210 and its movement, to generate greater potential energy resulting in more than 90% round trip efficiencies.

In one embodiment, the system 200 utilizes the EV chassis 210, flywheel 222 with the generator 226, counterweights (218A, 218B), rack and pinion arrangement 224 configured to connect the track 204 and generator 226, and walking beams (202A, 202B) that converts potential energy into kinetic energy through the movement of the EV chassis 210 on the track 204. The system 200 benefits from the inclined walking beams (202A, 202B) and leverage to use a small amount of energy to lift a small weight to create much greater potential energy resulting in a previously unattainable of at least 90% round-trip efficiency and a significantly longer-duration energy storage system.

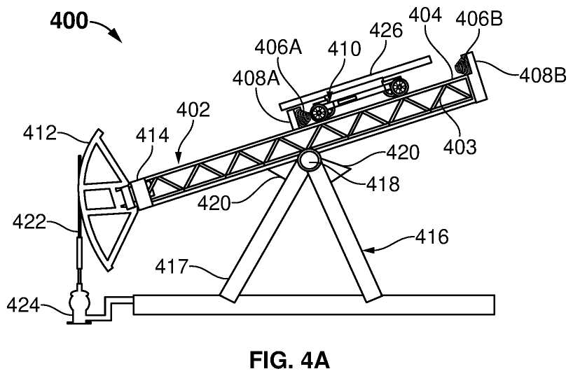

Referring to FIG. 3, a graph 300 illustrating the positioning of one or more components of the system 200 according to one embodiment is disclosed. In the graph 300, W represents two counterweights (218A, 218B), X represents the 5 feet distance between the counterweights (218A, 218B) and axle 214, L represents the 50 feet travel distance of the track 204, and F represents the force presented by 10,000 pounds EV chassis 210. A standard equipment EV chassis has 200 kWh battery packs with manufacturer estimated range of 400 miles or 2 miles per kWh. As the present invention requires Standard equipment EV chassis to carry an extra 2,000 pounds payload and travel on a 20-30 degree incline, it is estimated the actual range is reduced to 200 miles or 1 mile per kWh.

Standard equipment EV chassis requires 10 seconds, at 6.82 MPH, to travel 50 feet back and forth (100 feet total) to make one complete cycle. In 1-minute, standard equipment EV chassis makes 6 complete cycles and travels 600 feet. In 1-hour, standard equipment EV chassis make 60 complete cycles and travel 36,000 feet (6.8 miles). For example, the battery backs for the system 200 of the present disclosure will have a 200-mile range, then divided by 6.8 miles (distance traveled by EV skateboards in one hour) equals 29.4 hours duration without factoring in regenerative braking. Battery packs can be coupled for longer durations, for example, 4 battery packs, to help achieve about 117 hours of duration. Online calculators indicate 100,000 pounds declining per second equals 135.6 kW electrical output. Assuming 4 battery packs with 117.6 hours duration, the present invention would be capable of generating about 15,946.56 kWh of storage. Hence, it is assumed that the loss in energy due to friction is 10%.

### Example

An apparatus in accordance with one embodiment of the present invention is adapted for generating artificial lift by utilizing solar-powered EVs and leverage. The apparatus comprises at least one EV chassis utilized as a prime mover traveling back and forth, at one end of a walking beam or platform or incline plane on samson posts. This back-and-forth action of the EV chassis raises and lowers the walking beam and attached sucker rod string. The EV chassis is a weight bearing electric vehicle (WBEV) or electrified weight bearing vehicle (EWBV).

The apparatus uses the walking beam attached with a 100,000-pound weight. The weight is attached to one end of the walking beam using one or more connecting rods. The walking beam pivots on an axle near the 100,000-pound weight. The walking beam is raised and lowered by the front and back movement of the EV chassis across the surface of the walking beam. The EV chassis comprises a weight mounted on it. The weight may be solar PV panels.

The EV chassis is utilized as a prime mover, which travels back and forth, at one end of the walking beam on upright support stanchion posts. This back-and-forth action of the EV chassis raises and lowers the walking beam and attached sucker rod string. The back-and-forth movement of the EV chassis is limited by two protective end stops. The limited travel distance is only 7 feet/round trip of the EV chassis. Due to the limited travel distance of the EV chassis, the EV battery is fully charged via 13′×20′ standard solar PV panels attached to the top of the EV chassis by standard solar array mounting brackets and connected to charging equipment/battery.

The EV chassis operates on its own internal batteries. As the EV chassis benefits from regenerative braking that is built into the EV chassis, it can run an estimated 8-10 hours before recharging. Additional battery packs can be added to the EV chassis to increase runtime. Also, the apparatus could be adapted to generate electricity to charge batteries or back-fed into the grid to offset other costs during operation in order to further extend the duration of the runtime.

In one embodiment, the apparatus uses a plurality of combined rails and roadway structures (CRARS) mounted on a common axle. The CRARS are individually raised and lowered in an alternating, seesaw, fashion by the EV chassis, traveling back and forth across the top surface. The EV chassis consists of a standard EV platform attached to a flatbed type rail car. The EV chassis is moved by the EV platforms and counterweights. The flatbed rail cars with steel wheels travel across steel rail tracks. Tread-less, solid rubber, EV tires travel across two outer steel I-beams. At rest, EV chassis are positioned above the axle of the CRARS for quicker activation and generation of electricity. Over ninety-nine percent (99%) of the total weight of EV chassis is offset by connected counterweights. This configuration allows EV chassis to move large amounts of weight with relatively little effort and with great efficiency by using the leverage principles. Further, counterweights are temporarily attached to the EWBVs and pull EWBVs along a slotted track in the CRARS, similar to launching aircraft on aircraft carriers. In an embodiment, the counterweights serve a dual purpose and additionally help to stop EWBVs.

The counterweights perform over 99% of the weightlifting (work). With the counterweights, the EV chassis ‘guide’ the EWBVs slightly beyond the center of the CRARS axle/axis to create a tipping point. The subsequent falling of the 10,000-pound weight of the EWBVs traveling downhill at a desired speed of about 3.4 to 6.8 miles per hour. The desired speed of EWBVs allow for the conversion of kinetic energy into electrical energy at a conversion rate of at least 90% by the kinetics' mechanical energy moving a conventional crank arm/chainring arrangement to rotate chain connected gear boxes attached to electrical generator.

Also, each CRARS serves as a platform for mounting, prefabricated, solar arrays and are connected, on-site, to form a plug-n-play, solar electric system (SES). During daylight hours, the electricity generated by the solar electric system is utilized to keep EV batteries charged. Excess electricity is back fed into the grid on demand using the same electrical equipment that the battery energy storage systems use to generate revenue. Further, the EV chassis operate on their own internal batteries and are charged from consistent regenerative braking as well as SES provided ‘on the fly’ inductive or cable charging for even longer duration. Additional battery packs can be added to EVs to further extend the duration.

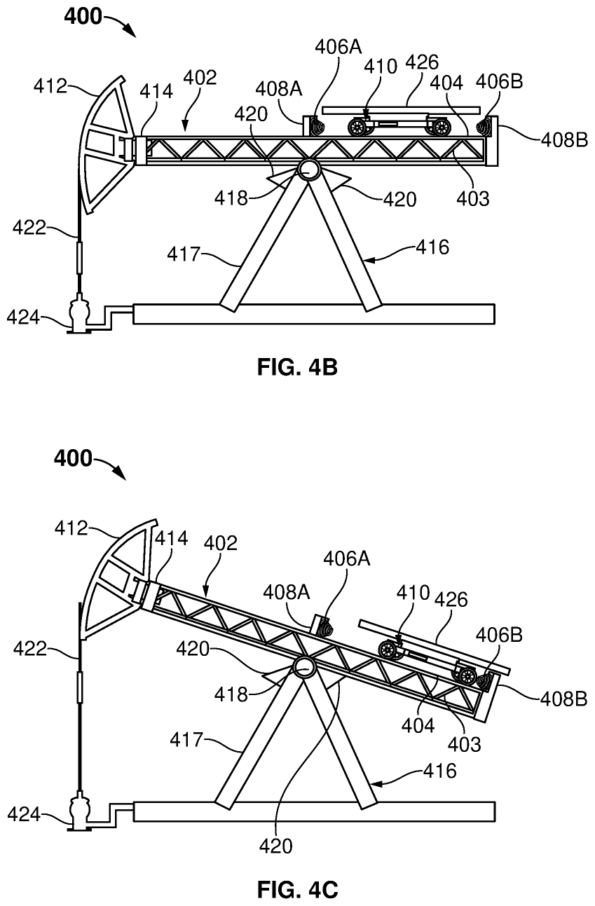

Referring to FIGS. 4A-4C, different views of an apparatus 400 for harnessing gravity to generate and store electrical energy according to one embodiment are illustrated. The apparatus 400 is a simple and inexpensive solution for harnessing gravity to generate and store electrical energy, as well as overcoming the geographic and technical problems associated with existing designs. The apparatus 400 features the back-and forth motion, similar to the conventional oil extracting pump jack.

The apparatus 400 provides a clean-tech experience for a long duration energy storage system. The apparatus 400 utilizes the mechanical advantages of leverage and an inclined plane to harness gravity for electricity generation. The apparatus 400 is adapted for generating artificial lift by utilizing solar-powered electric vehicles (EV) and leverage. The apparatus 400 artificially lifts fluids using solar energy as a readily available source of no-cost fuel.

The apparatus 400 comprises at least one walking beam or inclined plane 402. The walking beam 402 has a length of about 28 feet. The walking beam 402 is a lattice framework roadway platform. The walking beam 402 comprises a plurality of lattice bars 403 interconnected in an articulated manner configured to form a walking beam lattice support structure. The walking beam 402 comprises a proximal end and a distal end. The walking beam 402 comprises a track 404 on the distal end. The walking beam 402 further comprises at least two protective end stops (406A, 406B) and one or more lead weights. The protective end stops (406A, 406B) are located on opposite ends of the track 404. The lead weights are 8-pound barbells. The lead weights are attached to the walking beam 402 via two 10-foot U-bolts (408A, 408B).

The apparatus 400 further comprises an electric vehicle (EV) chassis 410. The EV chassis 410 is advantaged by regenerative braking. The EV chassis 410 is allowed to move back and forth on the track 404. The EV chassis 410 is positioned on top and connected to the track 404 to move along the length of the track 404. The back-and-forth movement of the EV chassis 410 is limited by the two protective end stops (406A, 406B). In one embodiment, the protective end stops (406A, 406B) are in the form of springs.

The apparatus 400 further comprises a curved metal head or horsehead 412. The curved metal head 412 is attached to the proximal end of the walking beam 402. The curved metal head 412 is attached to the proximal end of the walking beam 402 via a connecting member or hand-built wooden-rack 414. The apparatus 400 further comprises one or more upright support stanchion posts 416 configured to support the walking beam 402. The walking beam 402 is supported by at least two upright support stanchion posts 416. The upright support stanchion posts 416 are stainless steel samson posts. The upright support stanchion post 416 is, in one embodiment, perpendicular to the walking beam 402.

The walking beam 402 is perpendicularly affixed to one end of the upright support stanchion posts 416 via an axle or pivot point 418. The axle 418 is placed in the middle of the walking beam 402 to allow for a greater stroke range. The axle 418 is cradled by at least two walking beam stops 420. The walking beam 402 serves as a framework for the curved metal head 412, protective end stops (406A, 406B), upright support stanchion posts 416 and cablings 417. Additionally, walking beam 402 is held to a maximum angle of about 20-degree declined by 3,000-pound protective end stops (406A, 406B) located on the upright support stanchion post 416.

The apparatus 400 further comprises a sucker rod string 422. The sucker rod string 422 has an upper end and a lower end. The upper end is attached to the curved metal head 412 and the lower end is attached to a subterranean wellhead 424. In one embodiment, the back-and-forth movement of the EV chassis 410 along the track 404 enables the walking beam 402 to tilt on the axle 418 of the upright support stanchion posts 416 to a maximum decline angle. The tilting of the walking beam 402 enables the curved metal head 412 to move up and down, thereby allowing the sucker rod string 422 to move up and down through the wellhead 424 and descends into the wellbore to artificially increase pressure and extract the fluid.

The apparatus 400 further comprises one or more solar PV panels 426. The PV panels 426 are attached to the top of the EV chassis 410 using one or more standard solar array mounting brackets. The PV panels 426 are connected to one or more charging equipment or EV batteries that are attached to the EV chassis 410. The EV panels 426 are configured to charge the EV batteries coupled to the EV chassis 410.

In one embodiment, the apparatus 400 features the axle 418 in the middle of the 28-foot walking beam 402 to allow for a greater stroke range. The EV chassis 410 moves back and forth along the track 404 of the walking beam 402. The EV chassis 410 is a 3-pound, 7.2VDC EV model. The EV chassis 410 moves back and forth seven feet to create the required motion for oil extraction. The EV chassis 410 moves back and forth in a limited fashion to create the required 3.5-feet back and forth motion for oil extraction. This limited movement permits the solarization of the EV chassis 410 for a completely self-contained means of extracting oil with no fuel required or greenhouse gas (GHG) emissions.

A test bench model of the apparatus 400 is created for generating electricity. The test bench model comprises a walking beam 402 having a track 404 configured to allow an electrical vehicle (EV) chassis 410 to travel on. The walking beam 402 is a single, hand-crafted 2′×4′×48′ piece of Masonite. The track 404 is a 1′×2′ frame. The EV chassis 410 is a 3-pound, 7.2VDC EV model. The walking beam 402 is attached with a curved metal head 412 at its proximal end via a connecting member 414. The connecting member 414 is a hand-built wooden rack. The wooden rack has a dimension of about 1′×4′. In one embodiment, the curved metal head 412 may include one or more flywheels with a gear and chain assembly. The walking beam 402 is situated on top of one or more upright support stanchion posts 416 via an axle 418. The axle 418 is placed 1-foot away from the proximal end of the walking beam 402. The axle 418 is a ¾″ wood dowel rod, approximately 14″ long. The upright support stanchion post 416 includes one or more walking beam stops 420. The walking beam stops 420 are ¾″ bearings that are inserted into 2 1″×4″ wooden upright support stanchion posts 416.

The EV chassis 410 moves back and forth along the length of the track 404, which causes the walking beam 402 to move up and down. The up and down movement of the walking beam 402 enables the curved metal head 412 to move up and down. When the EV chassis 410 is remotely activated to run back and forth and the walking beam 402 is depressed by the falling 16 pounds of lead weights, the flywheels will rotate. The 16 pounds of lead weights are lifted and dropped by the weight of the model EV chassis 410 traveling back and forth on the track 404. When the EV chassis 410 reached the opposite end of the track 404, the lead weights rise. When the EV chassis 410 is traveled back to the end with the lead weights, the EV chassis 410 and lead weights are dropped.

Running the EV chassis 410 back and forth shows that the leveraged 3-pound EV chassis 410 could lift and create 16 pounds of potential energy. A small electrical generator is attached to one of the flywheels to generate electricity. Despite only using one walking beam 402 and one EV chassis 410, the flywheels maintained a constant rotation of 10 seconds and produced an electrical output of up to 9.2VDC, as measured by multimeter.

Another test bench model of the apparatus 400 is created for artificially lifting fluid. In this test bench model, the walking beam 402 serves as a framework for the curved metal head 412, protective end stops (406A, 406B), upright support stanchion posts 416 and cablings 417. The steel curved metal head 412 can be found off-the-shelf, and the size depends on the weight of the sucker rod strings 422. The protective end stops (406A, 406B) have standard size and made of steel. The protective end stops (406A, 406B) are composed of auto springs. The tension of the springs is between 3,000-5,000 pounds. The moving EV chassis 410 makes contact with the protective end stops (406A, 406B) on both ends of the track 404. The upright support stanchion posts 416 are arranged in a tripod formation and are composed of 3 steel girders that are approximately 30-feet long. The length of the cablings 417 would depend on the weight of sucker rod strings 422 as well.

In one embodiment, the walking beam 402 is held to a maximum decline angle of up to 30 degrees by the walking beam stops 420 located on the upright support stanchion posts 416. The walking beam 402 is mounted in the middle of the axle 418 affixed to the upright support stanchion posts 416. The walking beam 402 is attached with the track 404 on one side and the curved metal head 412 on the opposite side. The curved metal heads 412 have been used for centuries and due to their elliptical shape, and they are a means of maintaining perpendicular alignment of the sucker rod strings 422 as they move up and down to extract oil.

The curved metal head 412 is attached to the sucker rod string 422, which breaks through the wellhead 424 and descends into the earth's wellbore. The sucker rod string 422 rises and lowers based on the speed of the movement of the EV chassis 410 across the walking beam 402. The back-and-forth movement of the EV chassis 410 on the track 404 causes the walking beam 402 to tilt on the axle 418 of the upright support stanchion posts 416. The maximum decline angle of the walking beam 402 is determined by the walking beam stops 420 on the upright support stanchion posts 416. The sucker rod string 422 moves up and down in the subterranean wellbore to artificially increase pressure and extract the fluid.

The back-and-forth movement of the EV chassis 410 raises and lowers the walking beam 402 and the attached 10,000-pound sucker rod string 422. The EV chassis 410 is utilized as a prime mover traveling back and forth, at one end of the inclined walking beam 402 on upright support stanchion posts 416. The back-and-forth movement of the EV chassis 410 enables the up and down movement of the walking beam 402 and the attached sucker rod string 422 to a maximum angle of 20 degrees at a maximum stroke range of 12 feet. The rate at which the walking beam 402 and sucker rod string 422 raise and lower varies depending on the age of the well. New wells move at a quicker rate, while older wells operate slower. The 7 feet round-trip distance for the back-and-forth travel of the EV chassis 410 enables the EV battery to fully charge via solar PV panels 426 attached to the top of the EV chassis 410. The solar array keeps the battery completely charged throughout the day and during nighttime operation.

As the EV chassis 410 has a limited 7-feet round trip of back-and-forth travel distance, it is feasible to keep the EV battery fully charged via a 4.8 kW solar PV panels 426 attached to the top of the EV chassis 410 and connected by charging equipment to the battery. The EV chassis 410 has a 200 kWh battery pack with a Chevrolet manufacturer estimated range of 400 miles or 2 miles per kWh. The EV chassis 410 weighs approximately 8,000 pounds on its own. As the present invention requires the EV chassis 410 to carry an extra 2,000 pounds payload and travel on a 20-degree incline, actual range is reduced to 200 miles or 1 mile per kWh, without factoring in regenerative braking. This also increases the total weight of the EV chassis 410 to about 10,000 pounds when the additional payload is included.

To achieve ten complete strokes per minute, the EV chassis 410 must travel 7 feet round-trip in 6 seconds. Therefore, the EV chassis 410 travels back and forth 70 feet in one minute. In one hour, the EV chassis 410 travels back and forth 4,200 feet or 0.8 miles. The EV chassis 410 will thus travel 19.09 total miles per day. On average, a 1 kW solar electric system generates 4.8 kWh per day. The 19.09 miles divided by 4 kWh equals 4.8 kW with a solar array made up of 12/400 W panels and measuring 13′×20′. The number of panels may differ depending on the energy consumption required by the EV chassis 410.

In one embodiment, the present invention utilizes a method for artificially lifting fluids from a borewell using the apparatus 400. The apparatus 400 comprises the walking beam 402 having the track 404 on one end and curved metal head 412 at another end. The track 404 comprises at least two protective end stops (406A, 406B) located on opposite ends of the track 404. The apparatus 400 further comprises the electric vehicle (EV) chassis 410 and a sucker rod string 422 having an upper end attached to the curved metal head 412 and a lower end attached to a subterranean wellhead 424.

The method comprises the following step of mounting the walking beam 402 in the middle of an axle 418. The axle 418 is affixed to one or more upright support stanchion posts 416. There is the step of allowing the EV chassis 410 to move back and forth between the two protective end stops (406A, 406B) on the track 404. In one embodiment, the back-and-forth movement of the EV chassis 410 is limited by the two protective end stops (406A, 406B). The back-and-forth movement of the EV chassis 410 raises and lowers the walking beam 402. There is another step of enabling the walk beam 402 to tilt on the axle 418 of the upright support stanchion posts 416 to a maximum decline angle. In one embodiment, the maximum decline angle of the walking beam 402 is determined by one or more walking beam stops 420 located on the upright support stanchion posts 416. There is another step of enabling the curved metal head 412 to move up and down, thereby allowing the sucker rod string 422 to move up and down through the wellhead 424 and descends into the wellbore to artificially increase pressure and extract the fluid.

Advantageously, the system of the present invention uses an EV chassis as a simple and efficient prime mover, thereby eliminating large electric motors powering the pump jack, and other components such as pitman arms, counterweights, crank arms, pulleys, V-belts, power shafts, gear reduction equipment, and other equipment found on traditional pump jacks. The apparatus is adapted for harnessing gravity to generate and store electrical energy and generating artificial lift by utilizing solar-powered electric vehicles (EV) and leverage. Further, the present invention benefits from incline planes and leverage to use a small amount of energy to lift a small weight to create much greater potential energy resulting in a previously unattainable of at least 90% round-trip efficiency and a significantly longer-duration energy storage system.

The foregoing description comprises illustrative embodiments of the present disclosure. Having thus described exemplary embodiments of the present disclosure, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method.

Many modifications and other embodiments of the disclosure will come to mind to one skilled in the art to which this disclosure pertains having the benefit of the teachings presented in the foregoing descriptions. Although specific terms may be employed herein, they are used only in generic and descriptive sense and not for purposes of limitation. Accordingly, the present disclosure is not limited to the specific embodiments illustrated herein. While the above is a complete description of the preferred embodiments of the disclosure, various alternatives, modifications, and equivalents may be used. Therefore, the above description and the examples should not be taken as limiting the scope of the disclosure, which is defined by the appended claims.

1. A system for harnessing gravity to generate, leverage, and store electrical energy, comprising:
one or more walking beams, wherein each walking beam comprises a track having at least two protective end stops located on opposite ends of the track, wherein each walking beam is affixed to one end of an upright support stanchion post via an axle,
a plurality of counterweights attached to the walking beam adjacent to the axle via one or more connecting rods;
an electric vehicle (EV) chassis positioned on top of the track and allowed to move back and forth on the track, wherein the back-and forth movement of the EV chassis is limited by the protective end stops; and
a flywheel attached to the walking beams via a rack and pinion arrangement,
wherein the back-and-forth movement of the EV chassis along the track causes the walking beam to move up and down, wherein the up and down movement of the walking beam is converted into a rotational movement via the rack and pinion arrangement to capture an alternately falling force of the counterweights, thereby rotating the flywheel for generating constant and uniform electrical output.

2. The system of claim 1, wherein the walking beams are connected and supported by a reinforced concrete support structure.

3. The system of claim 1, wherein the protective end stops are in the form of springs.

4. The system of claim 1, wherein the protective end stops at the ends of the tracks are connected to another end of the upright support stanchion posts via a support cabling.

5. The system of claim 1, wherein the upright support stanchion post is perpendicular to the respective walking beam.

6. The system of claim 1, wherein the connecting rod moves vertically configured to allow the corresponding walking beam to move up and down within a desired range.

7. The system of claim 1, wherein the EV chassis is positioned on top and connected to the track configured to move along the length of the track.

8. The system of claim 1, wherein the back-and-forth movement of the EV chassis on the track at a desired speed generates electrical energy.

9. The system of claim 1, wherein the EV chassis moves continuously on the track using a connection between the upright support sanction posts and the track at an axis.

10. The system of claim 1, wherein the EV chassis moves along the track through gravitational effect of the counterweights against the weight of the EV chassis.

11. The system of claim 1, wherein the falling force of the counterweights utilizes gravitational energy that enables the EV chassis to travel back and forth on the track to efficiently control the weight of the EV chassis for generating electricity and long-term energy storage.

12. The system of claim 1, wherein the counterweights leverage the weight of the EV chassis and its movement along the length of the track to generate more potential energy.

13. The system of claim 1, wherein the walking beams are inclined to the upright support stanchion posts and leveraged to use a small amount of energy to lift a small weight to create more potential energy.

14. The system of claim 1, wherein the back-and-forth movement of the EV chassis causes the walking beam to move up and down configured to convert the potential energy of the walking beam into kinetic energy.

15. The system of claim 14, wherein the potential energy is converted into kinetic energy through a clockwise movement of the flywheel.

16. The system of claim 15, wherein the kinetic energy is converted into a rotational movement of the flywheel configured to generate constant and uniform electrical energy.

17. The system of claim 1, wherein the flywheel comprises an electrical generator configured to store the generated electrical energy.

18. The system of claim 1, wherein the flywheel is connected to the electrical generator via the rack and pinion arrangement.

19. The system of claim 1, further comprises one or more solar PV panels attached to the top of the EV chassis configured to charge a battery unit coupled to the EV chassis.

20. The system of claim 1, wherein the system is adapted for generating artificial fluid lift by utilizing back and forth movement of the EV chassis.
